(19) United States
(12) Patent Application Publication
(10) Pub. No.: US 2018/0134600 A1
(43) Pub. Date: May 17, 2018

(54) Low Temperature Process For The Reuse of Waste Glass

(71) Applicant: Florence Ann Morhauser, Soquel, CA (US)

(72) Inventor: Florence Ann Morhauser, Soquel, CA (US)

(73) Assignee: ANNIEGLASS, Watsonville, CA (US)

(21) Appl. No.: 15/717,362

(22) Filed: Sep. 27, 2017

Related U.S. Application Data
(60) Provisional application No. 62/497,242, filed on Nov. 14, 2016.

(51) Int. Cl. C03B 19/02; C03C 19/00; C03B 25/02; C03B 33/00

(52) U.S. Cl. CPC C03B 19/02; C03B 33/00; C03B 25/02; C03C 19/00

(57) ABSTRACT

A process for the reuse of waste glass at relatively low temperatures to create commercial glass products. The steps of the process include filling a tray with waste glass, placing the tray inside a kiln, heating the kiln to a sequence of stages, each stage having a designated temperature and a designated time interval, the stages including initial heating, soaking, annealing and then reducing the temperature to reach ambient temperature. The tray is then withdrawn and a glass block is taken out of the tray. The glass block is then precision cut to create a commercial glass product.

### BACKGROUND

The reuse of scrap glass is the processing of waste glass into usable products. Glass makes up a large component of household and industrial waste. In many cases waste glass is simply thrown out and added to municipal waste. In some cases, scrap, or waste, glass is recycled, i.e. collected for reuse. However, in many cases scrap glass is dumped into landfills because it is not economically viable to recycle.

Many companies use glass to create products for the home and commercial uses. One example is Annieglass, located in Watsonville, Calif., which manufactures a broad range of household products including bowls, plates, trays and cutting boards. The manufacturing of these products generates a large amount of waste glass. Disposing of waste glass poses a number of problems. One such problem is that due to the weight of glass, the cost of transporting waste glass is high compared to its financial return. As a consequence, there is a scarcity of glass production and reuse facilities that incorporate waste glass into their products and most waste glass typically ends up in landfills.

Further, conventional processes for the reuse of glass typically require the waste glass to be liquified at a high temperature, approximately 2600-2900 degrees F., depending on the composition of the materials used for making the glass. Thus, glass reuse by standard methods results expends a substantial amount of energy and is often not cost effective, especially when the cost of transporting the waste glass is factored in. For example, it is estimated that producing 1 KG of glass requires 5,000 to 6,950 watt hours of energy. By comparison, producing 1 KG of steel requires 830 to 1,950 watt hours of energy.

One current cost-effective use for recycled glass is to make bottles. However, the process for making bottles from waste glass involves turning waste glass into cullet, small pieces of crushed glass, and then heating the cullet with other materials to temperatures in the liquefication range (2600-2900 degrees F.).

However, glass first melts or softens at a considerably lower temperature, known as the glass transformation temperature range, at which glass changes exhibiting solid characteristics to exhibiting the characteristics of a liquid. At this lower transformation temperature range, typically between 1300 degrees F. to 1800 degrees F., glass melts or softens but does not entirely liquefy. Thus, a process for the reuse of waste glass in the lower glass transformation temperature range, as opposed to the considerably higher liquefication temperature range, would result in a significant energy saving and would also prevent a portion of waste glass from ending up in landfills.

An additional benefit of a relatively low temperature process for the reuse waste glass is that commercial kilns, typically used for ceramics, can be used. Thus, a lower temperature process would enable the reuse of waste glass on a broad scale. In contrast, machines used for glass production are typically very expensive and require specialized industrial facilities.

Thus, it would be desirable to be able to process waste glass at lower temperatures to create new glass products from waste glass. Such a process would create a secondary value for waste glass that would significantly contribute to the conservation of energy resources.

### SUMMARY OF THE DESCRIPTION

Various embodiments of the subject invention include processes for the reuse of waste glass at relatively low temperatures. These processes enable creation of decorative and building products from waste glass.

In one embodiment, a process for the reuse of waste glass to create commercial products is disclosed. The steps of the process include filling a tray with waste glass, placing the tray inside a kiln, heating the kiln to a sequence of stages, each stage having a designated temperature and a designated time interval, the stages including initial heating, soaking, annealing and then cooling, i.e. reducing the temperature of the kiln, to reach ambient temperature. The tray is then withdrawn and a glass block is taken out of the tray. The glass block can then be cut and smoothed to create a commercial glass product. In certain embodiments, waterjet technology is used to precisely cut the glass block into shapes that will be used for commercial products.

In certain embodiments, a decoration is applied to the waste glass before it is heated in the kiln.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates an embodiment of a tray into which waste glass is placed.

FIG. 2 illustrates an embodiment of a kiln that is loaded with several trays, each tray loaded with waste glass.

FIG. 3 illustrates an embodiment of blocks of glass that result from a process for the reuse of waste glass.

FIG. 4 illustrates an embodiment of the temperature stages used to heat waste glass during the process for the reuse of waste glass.

FIG. 5 illustrates several representative recycled glass houseware products.

FIG. 6 is a flow diagram illustrates the steps in one embodiment of the process for the reuse of waste glass.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

As used herein the following terms have the meanings given below:

Kiln refers to a type of oven that is typically used for heating, burning or baking glass clay or ceramic materials with the objective of melting and/or annealing them.

Tray refers to a structure that holds waste glass and that can be placed inside a kiln and heated without degrading or otherwise being affected by the heat in the kiln. As used herein a tray typically is rectangular, and has a bottom and sides. However, other shapes and structures can be used without departing from the spirit and scope of the subject invention.

Waste or scrap glass refers to glass that is a byproduct of creating or manufacturing a glass-based product such as a plate or decorative item. It may also result when a glass product, such as a glass houseware or a window is broken. Waste glass typically refers to broken glass, e.g. shards of glass. More generally, as used herein waste glass refers to broken glass, crushed glass, cullet, float glass, broken sheet glass and most other types of broken glass that have no further primary commercial value. However, the process disclosed herein does not work with tempered glass.

Recycling of waste glass refers to the collection of waste glass and may include the transportation of the collected waste glass to a recycling center, glass production facility, or to another facility.

Reuse of waste glass refers to the production of glass products that incorporate waste glass.

### Generalized Process

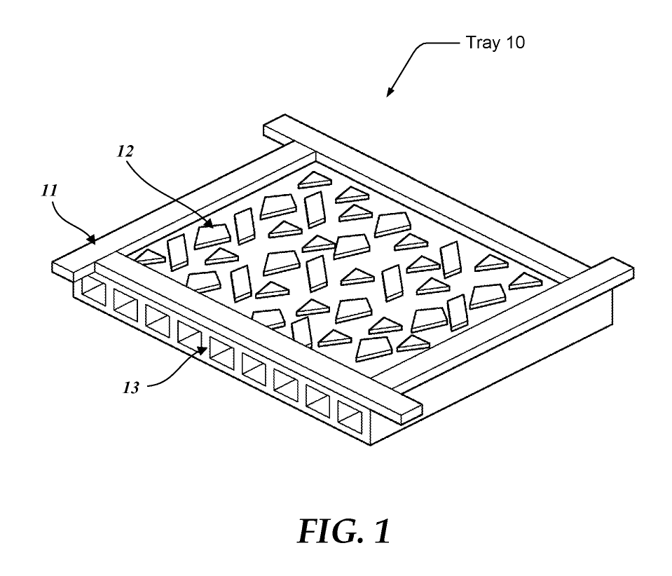

The following description covers embodiments of a process for the reuse of waste glass. The process and the various elements used therein are described below with respect to FIGS. 1-6.

FIG. 1 illustrates an embodiment of a tray 10 into which waste glass 12 is placed. Tray 10 has four sides 11 and a bottom 13. Sides 11 and bottom 13 are made of a material such as ceramics, including hardened clay, brick and tile, that doesn't melt at high temperatures. As illustrated, bottom portion 13 has baffles that allow air to flow thus creating a more uniform temperature. The top of tray 10 is open or uncovered.

In a most preferred embodiment, the sides are 1 to 5 inches high and 12 to 32 inches wide. The height of the sides determines the height of the tray and thus constrains the height of a block of melted glass that will result when the tray is heated in a kiln. In other embodiments, the sides may be 0.5 to 12 inches high. In certain embodiments, a larger tray that fills a kiln may be used. Such a tray can be 5′ on a side or even larger, depending on the size of the kiln into which it fits. It may be appreciated that tray sizes larger than a preferred size may require longer soaking and annealing periods, as discussed in further detail hereinbelow. Further, tray shape is not constrained to a square and may be rectangular, or another convenient shape.

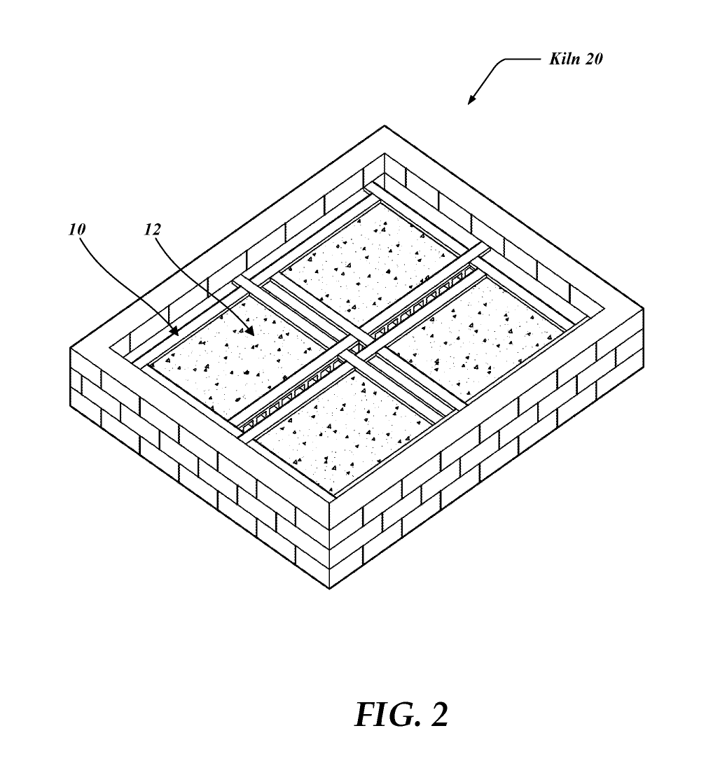

FIG. 2 illustrates an embodiment of a kiln 20 that is loaded with several trays 10, each tray loaded with waste glass 12. In this illustration, four trays 10 are shown. In addition, trays 10 may be stacked several deep within kiln 20. Typically, 1-8 trays can be stacked vertically within a kiln. Thus, a single kiln may comfortably hold 1 to 32 trays. Kiln 20 typically includes a lid (not depicted) that is typically closed when kiln 20 is heated.

Kiln 20 may be a standard commercial kiln, such as an electric or gas kiln typically used for ceramics or for glass.

Prior to placing a tray into a kiln an optional decoration may be applied. For example, in certain embodiments, gold leaf or another decoration material is painted onto the top a selection of the glass shards in the tray. As used herein, the term decoration refers to a material applied to glass for a decorative purpose that can withstand the heating process and which add a decorative aspect. Decorations may include inter alia gold luster, glaze, enamel, precious metal, colored glass, pigment, and gold leaf. In other embodiments, no decoration is applied. In yet other embodiments, a decoration may be applied after heating, i.e. after the corresponding block 30 is withdrawn from the kiln. For example, paint may be applied directly to block 30 after it has been withdrawn from the kiln.

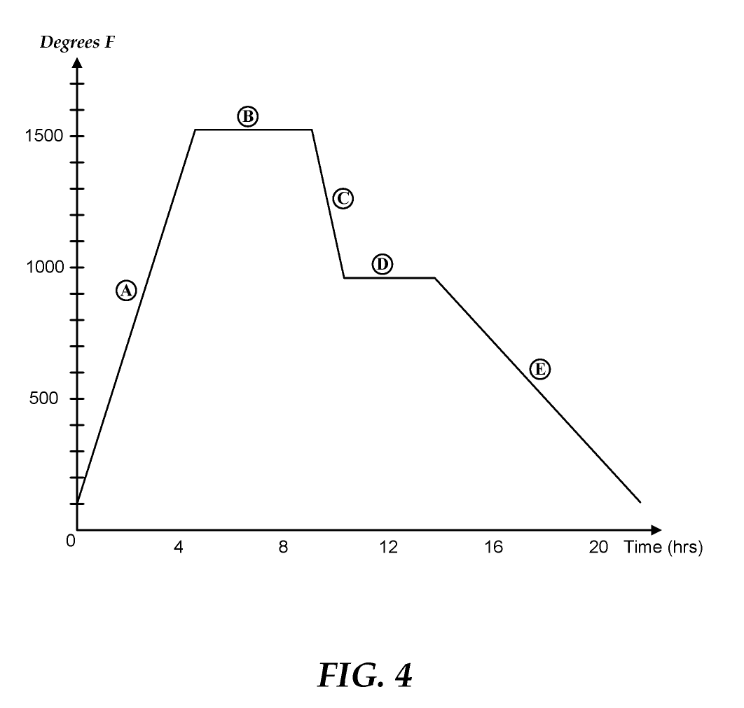

After kiln 20 is loaded with trays 10 lid 22 is closed and a heating program commences. There are several stages to the heating program, as described hereinbelow with reference to FIG. 4. The result of the heating program is that the waste glass held within each tray 10 melts and forms a glass block 30 that is substantially the same dimension as the width and length of the interior of tray 10. The height of the glass block is approximately the same depth as the depth of the waste glass loaded into tray 10.

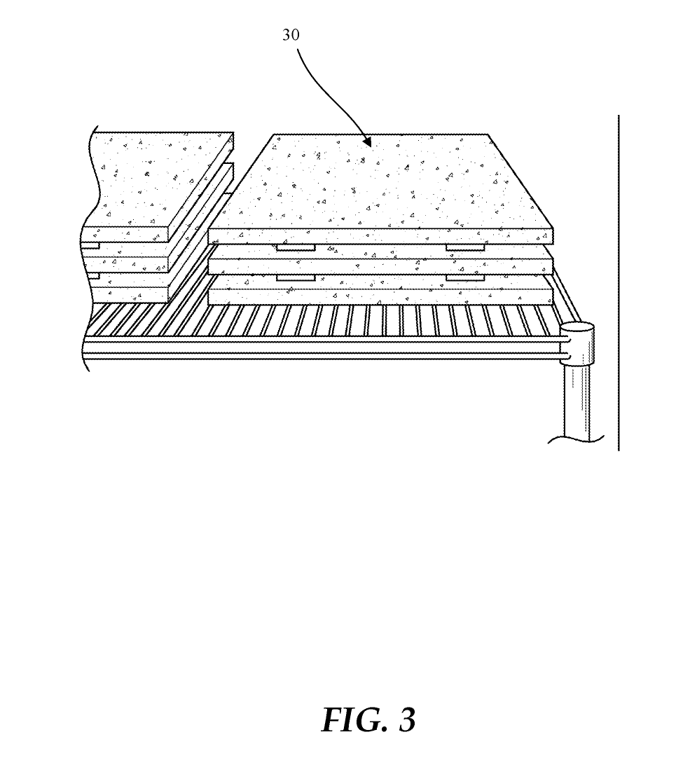

FIG. 3 illustrates an embodiment of blocks 30 of glass that result from the process for the reuse of waste glass. Each tray 10 that is heated in kiln 20 yields one block of glass 30. Each block of glass is square with a 22″ side and is 1 to 3 inches in depth.

Heating Stages

FIG. 4 illustrates an embodiment of the temperature stages used to heat waste glass during the process for the reuse of waste glass. The exact temperatures and durations for each stage will vary depending on the thickness of the waste glass, the amount of glass in each tray 10, i.e. the height to which tray 10 is filled with waste glass, the type of waste glass, ambient temperature, barometric pressure, and the time that it takes a particular kiln to reach a target temperature. However, considerable experimentation indicates that the heating stages disclosed hereinbelow are important to achieving a satisfactory result. Generally, the temperatures and times disclosed herein for each heating stage are based on the assumption that the waste glass is from ⅛ to ⅜ inches and that the tray is substantially filled with waste glass to a depth of 1 to 3 inches. Temperatures for other tray sizes and depths can be determined experimentally without undue experimentation. The stages are:

Stage A—Initial heating. The kiln is heated to a soak temperature. The soak temperature is typically in the range of 1400 to 1700 degrees F., typically this temperature range is in the range of temperatures associated with the glass transformation temperature range at which glass softens and become malleable. This step may take from 0.5 to 4 hours.

Stage B—Soak. The temperature is held constant at the maximum temperature, allowing the waste glass to completely melt. In a most preferred embodiment, a soak time of approximately 3 hours in a preferred range of 1500-1600 degrees F. Generally, soak times may range from 2 to 5 hours in a range of temperature from 1400 to 1700 degrees F.

Stage C—Reduce temperature to annealing temperature. The temperature of the kiln is rapidly reduced to an annealing temperature of 800-950 degrees F. This decrease in temperature typically occurs over an interval from 0.5-2 hours.

Stage D—Annealing. The temperature is held at the annealing temperature for a period of time. This step may take 0.5 to 2 hours. The annealing temperature is referred to as a stress-relief point or annealing point of the glass. At such a viscosity, the glass still is too hard for significant external deformation without breaking, but it is soft enough to relax internal strains by microscopic flow in response to the intense stresses they introduce internally. The trays 10 in the kiln heat-soak at the annealing temperature until their temperature is even throughout and the stress relaxation is adequate.

Stage E—Cooling. The temperature is decreased to ambient temperature over a relatively long period. This step may take from 2-12 hours.

The result of this heating process is that the waste glass in each tray is melted to form a glass block of a desired thickness. For each of the stages, the designated time interval and temperature is given in Table 1 below:

TABLE 1
Designated Time Intervals and Temperature Ranges

| | Designated | | Designated |
|---|---|---|---|
| | Time | | Temperature |
| Stage | Interval | | Range |
| A-Initial Heating | .5 to 4 | hours | Ambient temp to |
| | | | Soak Temp. |
| B-Soak | 2 to 5 | hours | 1400-1700 F. |
| C-Reduce Temp. | .5 to 2 | hours | Soak to Anneal |
| | | | Temp. |
| D-Annealing | .5 to 2 | hours | 800-950 F. |
| E-Cooling | 2-12 | hours | Anneal temp to |

ambient temp

### Creating Products

Many commercial products may be created from glass blocks 30. For example, glass blocks 30 may be used as siding, windows, or tiles. Several additional steps are described below that are used to create a class of houseware products referred to herein as recycled glass houseware. One such line of commercial products that uses this process is named GREENIEGLASS and is provided by ANNIEGLASS of Watsonville, Calif.

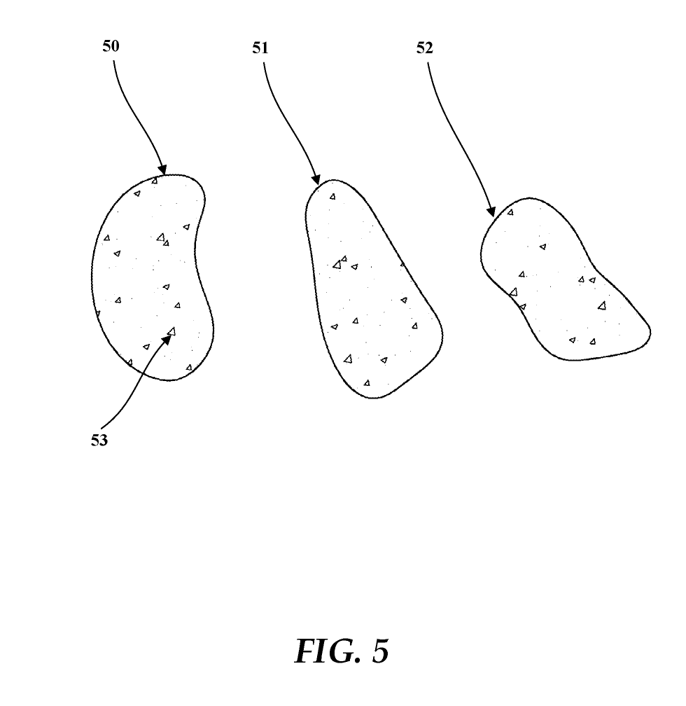

FIG. 5 illustrates several representative recycled glass houseware products 50-52. Each of products 50-52 has a decoration 53 applied. As previously described, in preferred embodiments, decoration 53 is typically applied before kiln is heated. During heating, decoration 53 undergoes a transformation and permanently adheres to a resulting block 30.

Each of products 50-52 is cut out from a block 30 using a device such as a water jet cutter, also referred to as water jet or waterjet. A waterjet is an industrial tool capable of precisely cutting a variety of materials, including glass, using a very high-pressure jet of water, or using a combination of water and an abrasive material. A waterjet avoids the high temperatures induced using other cutting tools.

After a shape is cut from a block 30 the edges are typically smoothed using a grinder or sanding device.

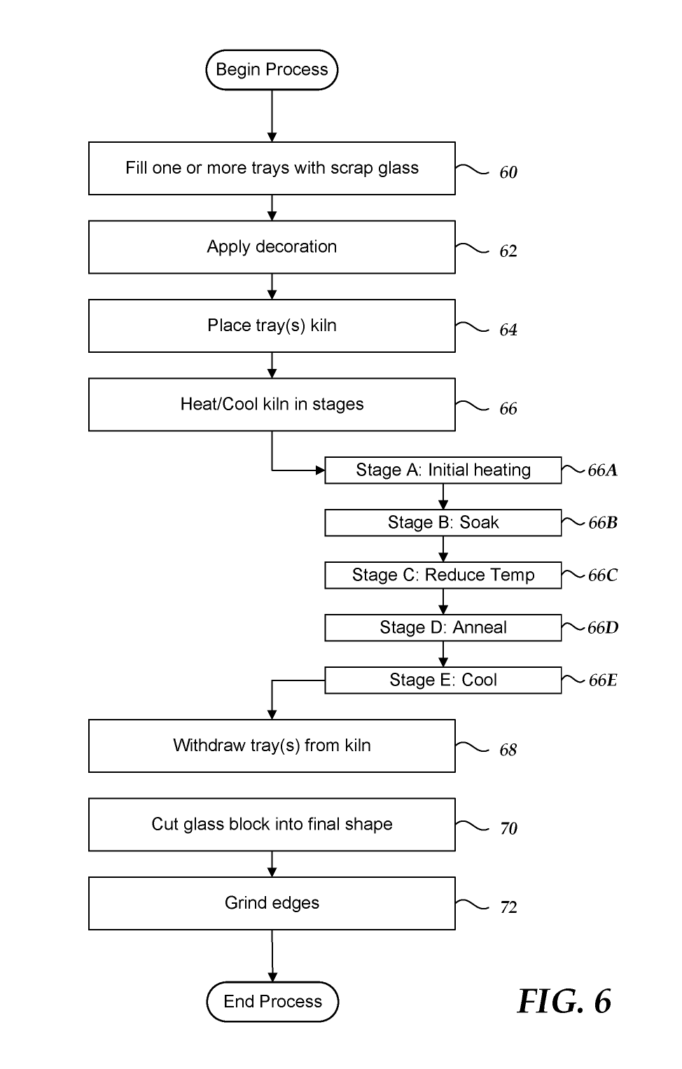

FIG. 6 is a flow diagram illustrates the steps in one embodiment of the process for the reuse of waste glass. The various steps illustrated in FIG. 6 summarize the steps described with reference to FIGS. 1-5 hereinabove.

At step 60 one or more trays 10 are filled with waste glass. It may be appreciated that prior art waste glass reuse processes typically include additional steps such as crushing glass to create cullet. Further, prior art glass processes typically combining waste glass with materials such as sand, soda ash and limestone. In contrast, no additional material needs to be combined with the waste glass in the process described with reference to FIG. 6. Waste glass alone can be placed in tray 10 and recycled to create secondary glass products with commercial value.

Optionally, at step 62 a decoration is applied to the waste glass.

Next, at step 64 the filled trays are placed in kiln 20. Then the kiln 20 is closed and a heating program commences.

As discussed, at step 66 kiln 20 is heated in stages, each stage having a designated time and a designated temperature. Step 66 has a series of substeps 66A-66E, each of which represents a heating stage. The stages are stage A-initial heating 66A, stage B-soak 66B, stage C reduce temperature to annealing temperature 66C, stage D-anneal 64D, and stage E-cool 64E.

The result of this heating process is that the waste glass in each tray 10 is melted to form a glass block of a desired thickness. After trays 10 are cooled to near ambient temperature then at step 68 the trays 10 are withdrawn they are taken out of the kiln and glass blocks are taken out of the trays.

It may be appreciated that stage B-soak (66B) is performed at a relatively low temperature when compared with prior art waste glass reuse processes. The objective of prior art glass recycled production methods results in as-new glass products such as bottles. In contrast, when the low temperature process is used then the waste glass is not liquefied and a visual remnant of the shape of the various shards of glass added to the tray at step 60 remains. This visual remnant can be described as a ghost image, a shadow, or a striation and is characterized by faint lines that correspond to edges of the glass shards within the resulting blocks of glass. In many cases, this low temperature process is entirely satisfactory to produce a wide variety of products, such as inter alia housewares, decorative objects, and building materials such as tiles. However, in cases where clear glass is required, the recycled glass that results from this process may not be acceptable.

Next, at step 70 a waterjet or comparable device is used to cut each glass block into its final shape. At step 72 edges are typically ground, polished or sanded to smooth them.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A low temperature process for the reuse of waste glass, comprising:
filling a tray with waste glass;
placing the tray inside a kiln;
heating the kiln to a sequence of stages, each stage having a designated temperature and a designated time interval, the stages comprising:
initial heating from ambient temperature to a designated soak temperature;
soaking at a designated soak temperature, wherein the soak temperature is in a range of 1400 to 1700 degrees F.;
annealing at a designated anneal temperature;
reducing the temperature to reach substantially an ambient temperature within the kiln; and
withdrawing the tray from the kiln, wherein the waste glass is formed into a glass block.

2. The process of claim 1 further comprising applying a decoration to the glass block before placing the tray inside the kiln.

3. The process of claim 1 further comprising cutting the glass block into a shape.

4. The process of claim 3 wherein a waterjet cutting device performs the cutting.

5. The process of claim 3 further comprising grinding the edges of the shaped glass block to smooth them.

6. The process of claim 1 wherein no material other than waste glass is added to the tray.

7. The process of claim 2 wherein no material other than waste glass and the decoration is added to the tray.

8. The process of claim 1 wherein the depth of the tray is between 1 and 5 inches.

9. The process of claim 1 wherein the waste glass has a thickness between ⅛ inch and ⅜ inches.

10. The process of claim 1 wherein the time interval of the soak stage is between 2 and 5 hours.

11. The process of claim 1 wherein the temperature of the soak stage is between 1500 and 1600 degrees F.

12. The process of claim 1 wherein the temperature of the annealing stage is between 800 and 950 degrees F.

13. The process of claim 1 wherein the time interval of the annealing stage is between 0.5 and 2 hours.

14. The process of claim 1 wherein the decoration is selected from the group consisting of gold luster, gold leaf, glaze, enamel, precious metal, colored glass, and pigment.
